(19) United States
(12) Patent Application Publication
(10) Pub. No.: US 2015/0254577 A1
(43) Pub. Date: Sep. 10, 2015

(54) SYSTEM AND METHODS FOR LOCATION BASED MANAGEMENT OF CLOUD PLATFORM DATA

(71) Applicant: NetSuite Inc., San Mateo, CA (US)

(72) Inventor: Craig Sullivan, Kingsburg, CA (US)

(21) Appl. No.: 14/567,934

(22) Filed: Dec. 11, 2014

Related U.S. Application Data
(60) Provisional application No. 61/949,589, filed on Mar. 7, 2014.

(51) Int. Cl. G06Q 10/00

(52) U.S. Cl. CPC G06Q 10/00; G06Q 2220/10

(57) ABSTRACT

Systems, apparatuses, and methods for enabling the operator and users of a multi-tenant business data processing platform to comply with local, national, or regional regulations concerning the transport and storage of certain types of data without compromising the utility of and benefits provided by the platform. When a business user or customer of a business in that region or country requests access to an application executed by, or data stored on, the multi-tenant business data processing platform, routing logic may determine if the use of the application and/or data will implicate restricted data. The routing logic may control routing of the request between an application resident on the central platform and either a central data store or a regional/local data center. The regional/local data center may use a local platform interface to receive the request and/or messages from the central platform and may include a data tokenizer to replace protected data with a suitable token before sending messages to the central platform.

### CROSS REFERENCE TO RELATED APPLICATION

This application claims the benefit of U.S. Provisional Application No. 61/949,589, entitled “System and Methods for Location Based Management of Cloud Platform Data,” filed Mar. 7, 2014, which is incorporated herein by reference in its entirety (including Appendix) for all purposes.

### BACKGROUND

Modern computer networks incorporate layers of virtualization so that physically remote computers and computer components can be allocated to a particular task and then reallocated when the task is completed. Users sometimes speak in terms of computing “clouds” because of the way groups of computers and computing components can be formed and split in response to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor are limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor are limited to only including): sales force automation (SFA), marketing automation, contact list management, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

Although much of the data stored in a data storage element (such as a database) of a multi-tenant business data processing platform may be financial, inventory, or other strictly business related data, the applications resident on the platform may also use other types of data when responding to a user's request for services. These other types of data may include private or personal data, such as employee social security numbers or governmental identification numbers, employee home addresses, employee demographic data, employee medical information, an eCommerce platform user's credit card account number or other payment information, etc. In some cases certain types of personal data (or other private data) may be subject to regulations imposed by a governmental entity that prevent such data from leaving a country or region. For example, certain personal data (such as credit card account numbers or social security numbers) may not be permitted to be stored or transported outside of a country of origin or region in which a person resides. As another example, medical data may be subject to regulation (such as HIPAA, the Health Insurance Portability and Accountability Act) which restricts its access, transfer, or use.

This situation can create a problem for the operator of a multi-tenant business data processing platform or system which uses protected or regulated data to generate responses to requests from business users, or which might need such data as part of executing an application for a user (such as an eCommerce or banking application). This is because the restrictions on data usage may reduce the utility of a global platform and central data storage for a business using the platform to manage its data and provide services to employees and customers. As a result, this situation may create a disincentive to use such a platform or offer certain functionality as part of the platform. This is particularly so when a user is likely to be located in a country or region in which certain data is subject to regulations but the platform or system is located and stores data outside of that country or region. For example, if the platform hosts an application that is used to calculate payroll or sales commissions based on CRM data, then the application may need to have access to an employee's social security number (or its equivalent) in order to perform the necessary data processing (including for example, tax calculations for one or more jurisdictions). But, if the platform is located in one region or country and the employee is located in a different country (and one in which such data is regulated), then the platform may not be permitted to store the regulated data. This situation would typically arise in the case of a multi-national corporation with employees located in multiple countries or regions.

Similarly, if a data processing platform stores data and applications used to process medical insurance claims, it will by necessity have access to personal and often confidential data that may be protected by one or more regulations or laws (such as HIPAA). These regulations or laws typically restrict the storage of such data to local areas and prohibit its transfer or storage outside of a state, country, region, etc. In such a case, it may not be possible to process claims arising from events in one country or region if the data processing platform is located in another country or region.

As another example, if a globally operating business wishes to make its eCommerce platform available to users in countries where certain personal or financial data (such as payment card account numbers, home address, etc.) is prohibited from being transferred outside of a specific region, then the data entered by customers in that region as part of completing a purchase might have to be stored locally and not transferred to a data processing platform located outside of that region.

A centralized data processing platform provides multiple benefits to a business since it stores a large amount of interrelated business data. Further, the applications on such a platform may be of a type that the business wants to make available to employees and potential customers located in multiple countries and regions. Although the business will want to be able to obtain the benefits of the platform's code base and centralized data storage, it still needs to comply with all local, national, or regional regulations concerning the transport or storage of certain data.

This could limit the utility of the platform by preventing platform applications from processing requests for service that require access to regulated data. As a result, business users will be prevented from obtaining the synergistic benefits of a data processing platform that has access to all relevant business data for use with applications designed to implement critical business functions. Note also that in the absence of a “cloud-based” data processing platform, a business may have to operate and maintain multiple regional or local data processing platforms and the associated infrastructure. This would not only be prohibitively expensive but would also complicate (and in some cases prevent) executives from having sufficient insight into regional or global operations in a timely manner.

Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for enabling the operator and users of a multi-tenant business data processing platform to comply with local, national, or regional regulations concerning the transport and storage of certain types of data without compromising the utility of and benefits provided by the platform. In one embodiment, the operator of the platform establishes one or more regional data centers that are used to store data that is subject to regulation or restriction within that region. When a business user or customer of a business in that region or country requests access to an application executed by, or data stored on, the multi-tenant business data processing platform, routing logic may determine if the use of the application and/or data will implicate restricted data. This may be based on one or more rules or conditions related to the location of the requestor (e.g., based on IP address, GPS use, etc.), the record or data type that may need to be accessed, the application or function being accessed, or other suitable criteria. The routing logic may control routing of the request between an application resident on the central platform and either a central data store or a regional/local data center. The regional/local data center may use a local platform interface to receive the request and/or messages from the central platform and may include a data tokenizer for purposes of “tokenizing” protected data and replacing that data with a suitable token before sending messages to the central platform. Thus, in some embodiments, the request routing logic functions as an intermediary between the applications installed on the central platform and one or more regional data centers.

If the request for service/application by the user implicates restricted data (typically either by accessing a service or application that processes such data or requesting access to such data), then the platform interface may become involved in one or more aspects of processing the request and/or a response generated by the multi-tenant business data processing platform. As an example, if the local platform interface is processing a user request in which restricted data is being provided (such as completing an order using a business' eCommerce platform, in which case credit card or other private data may be requested), then the platform interface may call a process to tokenize or otherwise operate to remove the restricted data and replace it with a “token” or form of identifier for that data. The restricted data is then stored locally (e.g., in a regional data center) and indexed for retrieval by the token or other form of identifier. The token is then used in the submitted request and/or data to replace and represent the restricted data.

Note that the terms “token”, “tokenize”, “tokenization”, or other similar terms represent a process, function, method, or operation in which data is replaced by a representation of that data. The representation may be one derived from the data (such as a hashing of the data), the result of encrypting the data, or replacing the data by a suitable identifier. Typically, the restricted data is removed from a request that might involve sending the data outside of its appropriate country or region and a token is put in its place in the request. The actual data is stored along with its identifier in a local or regional data center.

The token or tokens contained in the request are received by the multi-tenant business data processing platform and stored in a central data storage center. When a request for a service or data is received that includes the restricted data as part of a response, a process in the multi-tenant business data processing platform and/or central data storage center inserts the token into the response in place of the restricted data. Upon receipt of a response to a user request, the local platform interface recognizes the token or tokens as representing restricted data, and accesses the regional data center to obtain the previously stored restricted data and place that data into the response before presenting it to the user. In this way embodiments of the invention permit restricted data to be confined to the appropriate state, country or region while permitting users to benefit from the efficiencies and synergistic benefits of a centralized multi-tenant business data processing platform and associated centralized data storage.

In some embodiments, the invention may include a combination of a routing logic engine and one or more local data stores. The local data stores may be used to store restricted data while a central data store may be used to store non-restricted data. The routing logic engine provides an intermediary logic between an application or service on a central platform and the local data stores. The logic engine enables the invention to determine whether there are data restrictions that apply to a user's access to a specific application or service and to store and access data (when needed) using a local data store. Additional logic may be used locally to identify restricted data that a user inputs or is expected to input, tokenize that data, and store the actual data locally while providing the tokenized version to the central platform. This combination of functional capabilities enables business users of the platform and their customers to optimize their use of the global platform's applications and services, as opposed to requiring that all requests and data access/usage be implemented by local servers and the supporting infrastructure. This makes the synergistic benefits and advantages of a central business data processing platform available in a more optimal fashion, as opposed to requiring that a local data store and local platform infrastructure be used to process all requests for services or data access for residents of a specific region or locality.

In one embodiment, the invention is directed to a method of operating a centralized data processing platform, where the method includes:

receiving a request for data or a service from a user at the centralized data processing platform;

processing the request to generate a response to the request, wherein the response includes one or more tokens representing data that is restricted to a specific country or region;

providing the response to an interface located within the specific country or region;

processing the response within the specific country or region to identify the one or more tokens;

using the one or more tokens to access the restricted data from a local data store located within the specific country or region;

replacing the one or more tokens with the restricted data; and

presenting the response to the user.

In another embodiment, the invention is directed to a data processing system, where the system includes:
a regional or local data storage element;
a central data processing platform interface;
a data tokenizer;
a central data processing platform;
a central data storage element; and
an electronic data processor configured to execute a set of instructions, wherein when the instructions are executed, the central data processing platform is caused to implement a process to
   receive a request for data or a service from a user at the centralized data processing platform;
   process the request to generate a response to the request, wherein the response includes one or more tokens representing data that is restricted to a specific country or region;
   provide the response to the central data processing platform interface located within the specific country or region;
   process the response within the specific country or region to identify the one or more tokens;
   use the one or more tokens to access the restricted data from the local data storage element located within the specific country or region;
   replace the one or more tokens with the restricted data; and
   present the response to the user.

In yet another embodiment, the invention is directed to an apparatus for use in operating a central data processing platform, where the apparatus includes:

an electronic data processor configured to execute a set of instructions, wherein when the instructions are executed, the central data processing platform is caused to implement a process to

receive a request for data or a service from a user at the centralized data processing platform;

process the request to generate a response to the request, wherein the response includes one or more tokens representing data that is restricted to a specific country or region;

provide the response to a central data processing platform interface located within the specific country or region;

process the response within the specific country or region to identify the one or more tokens;

use the one or more tokens to access the restricted data from the local data storage element located within the specific country or region;

replace the one or more tokens with the restricted data; and

present the response to the user.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components that may be present in a computer device or system configured to implement a method, process, function, or operation in accordance with an embodiment of the invention;

FIG. 2 is a diagram illustrating elements or components of an example operating environment in which an embodiment of the invention may be implemented;

FIG. 3(a) is a diagram illustrating additional details of the elements or components of the multi-tenant distributed computing service platform of FIG. 2, in which an embodiment of the invention may be implemented;

FIG. 3(b) is a block diagram illustrating a system architecture in which one or more regional data centers are used in conjunction with a central data center and multi-tenant business data processing platform to restrict the transfer or storage of restricted data outside of the appropriate region or country, and that may be used when implementing an embodiment of the invention;

FIG. 3(c) is a block diagram illustrating certain of the components or elements of a regional data center and associated elements, as shown in FIG. 3(b);

FIG. 4 is a flow chart or flow diagram illustrating a process, method, operation, or function for protecting restricted user data from being stored or transferred outside of a specified region or country, and that may be used in implementing an embodiment of the invention;

FIG. 5 is a block diagram illustrating components and the associated data flow of a system that may be used to implement an embodiment of the invention; and

FIG. 6 is a flow chart or flow diagram illustrating a process, method, operation, or function for using routing logic to determine how to access an application or service resident on a central data processing platform, and that may be used in implementing an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for controlling the use, access to, the transmission of, and the storage of data that is subject to governmental or other regulatory restrictions within an architecture that includes a central multi-tenant data processing platform. Such data may include personal data, medical data, social security numbers or other similar identifiers, credit card account numbers, etc.

In one application of the inventive system and methods, embodiments of the invention operate to replace such restricted data with a “token” and to store the restricted data in a local or regional data storage element in a manner that permits retrieval of the data based on the token. The token is used to replace the restricted data in data provided to a central (outside of the region in which the data restriction(s) apply) data storage element, which is typically associated with a multi-tenant data processing system or platform. The token is stored in the central data storage element and inserted in responses to user requests from users located within the region in which the data restriction(s) apply (note that if a user located outside of the region in which the data restriction(s) apply should request restricted data or an application that would access or process restricted data, then the response to that request may include the token or a suitable placeholder along with an explanation of why the data cannot be provided to the user). Upon being received by a platform interface element located in the region in which the data restriction(s) apply, the token is replaced by the locally stored restricted data and the response is then presented to the user.

In the same or another embodiment of the invention, the inventive system and methods may operate to determine if a request to access an application or service installed on a central platform (e.g., an eCommerce or HR application) will involve the input, use, or access to restricted data. If so, then certain of the data handling aspects involved in responding to the request are implemented by a local data store and a data tokenizer instead of by the central platform and a central data store.

As described, in one embodiment, the inventive system and methods may be used to protect against the (prohibited) non-local storage or transfer of restricted data by storing such data in a local or regional data store, and replacing the data with a suitable token or other form of identifier. The token or identifier may be stored in a central data store and used as part of providing a response to a user request for information or providing a user with access to a service or functionality. For example, if a user is using an eCommerce functionality to make a purchase, then their payment account number may be considered restricted. If so, then when they attempt to complete the transaction, their payment account number may be removed by a local interface and stored locally, while a token associated with the payment account is provided to the central data processing platform. This permits the order to be placed and processed (and inventory or sales data updated) by a central platform, with clearance and settlement of the transaction performed locally.

Similarly, a human resources representative of a multi-national company may be located in a country or region in which non-local storage of certain personal information is prohibited. In such a case, the inventive system and methods may be used to remove the restricted information from data inputs, messages, requests, etc. submitted by the representative to a central platform, and replace the removed information with an appropriate token. The protected information may be re-inserted by a local interface prior to presentation of the results of a request or data processing operation to the representative.

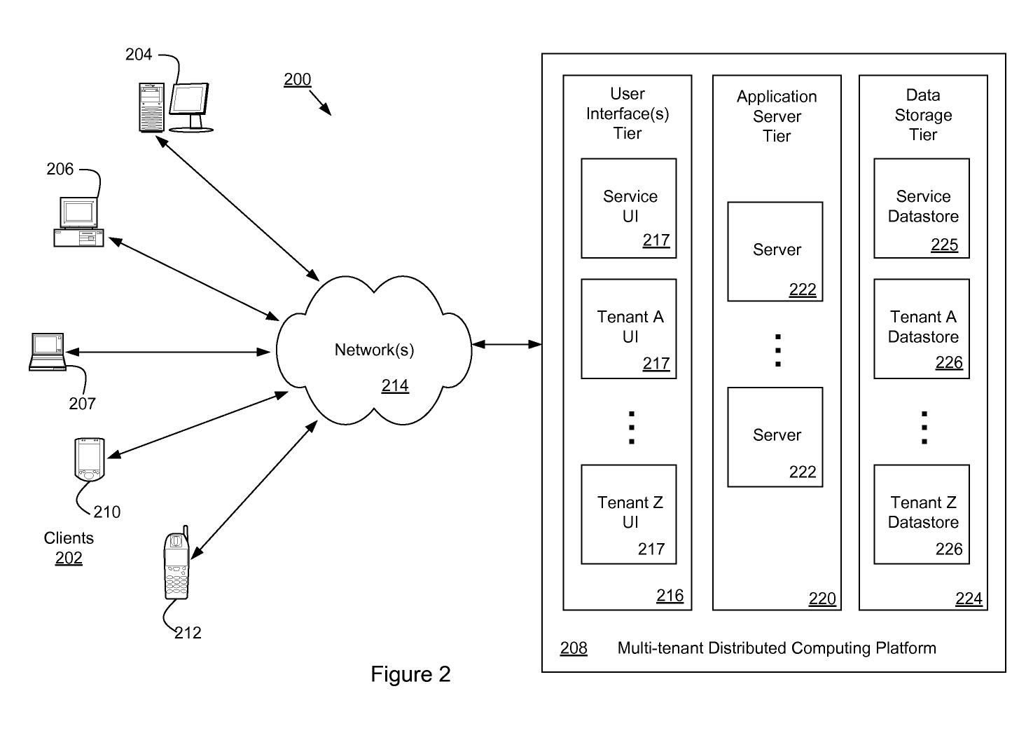

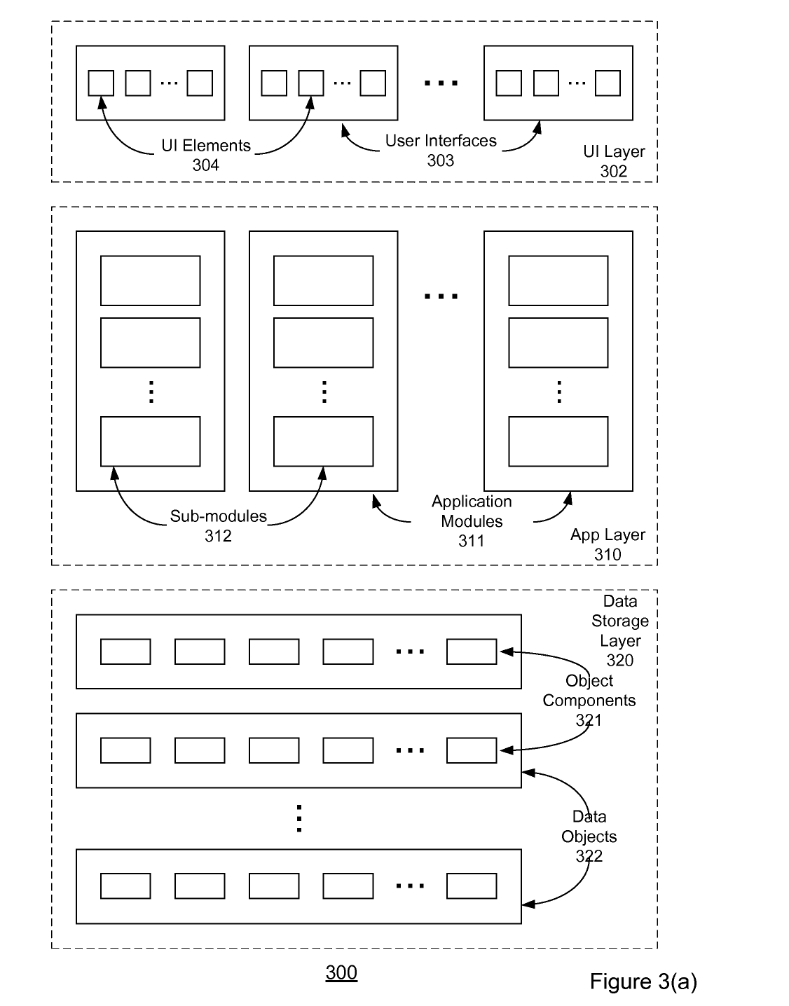

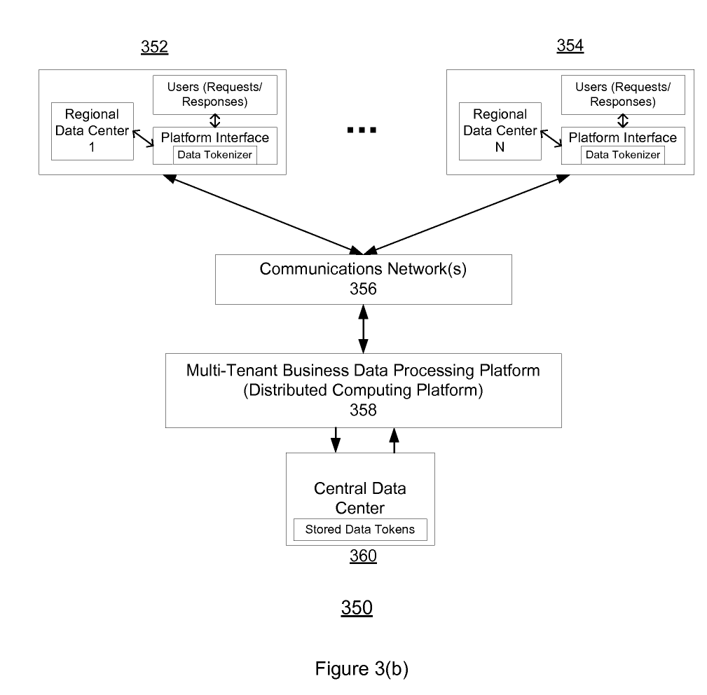

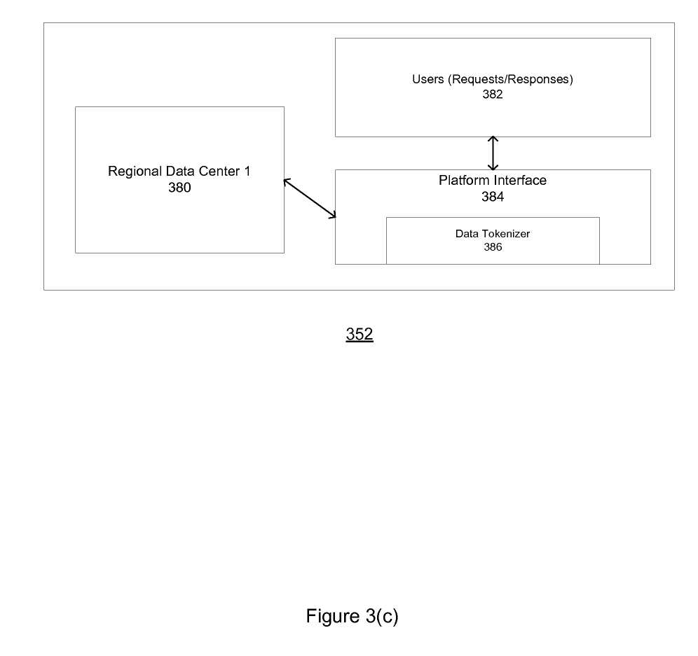

In some embodiments, the invention may be implemented in the context of a multi-tenant, “cloud” based environment, typically used to develop and provide services and business applications for end users (who may be the employees or customers of a business). This exemplary implementation environment will be described with reference to FIGS. 2 and 3(a). Note that embodiments of the invention may also be implemented in the context of other computing or operational environments or systems, such as for an individual business data processing system with installations in multiple regions or countries, a remote or on-site data processing system, other forms of client-server architecture, etc.

FIG. 2 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions.

The data storage tier 224 may include one or more data stores, which may include a Service Data store 225 and one or more Tenant Data stores 226. Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality (such as by using a Software-as-a-Service model). These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of a service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functional capabilities may advantageously be integrated and executed by a single code base accessing one or more integrated databases as necessary, forming an integrated business management system or platform.

The integrated business system shown in FIG. 2 may be hosted on a distributed computing system made up of at least one, but typically multiple, “servers.” A server is a computer dedicated to run one or more software services intended to serve the needs of the users of other computers in data communication with the server (for example via a public network such as the Internet or a private “intranet” network). The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is most often a combination of hardware and software that helps deliver content (typically by hosting a website) to client web browsers that access the web server via the Internet.

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs.

FIG. 3(a) is a diagram illustrating additional details of the elements or components of the distributed computing service platform of FIG. 2, in which an embodiment of the invention may be implemented. The software architecture depicted in FIG. 3(a) represents an example of a complex software system to which the methods, operations, functions, and processes used as part of an embodiment of the invention may be applied (and/or which may be used in implementing one or more of the methods, operations, functions, or processes used by an embodiment of the invention). In general, an embodiment of the invention may be used in conjunction with a system that includes a set of software instructions that are designed to be executed by a suitably programmed processing element (such as a CPU, microprocessor, processor, controller, computing device, etc.) for purposes of accessing, storing, and processing business related data. In a complex system such instructions are typically arranged into “modules” with each such module performing a specific task, process, function, or operation. The entire set of modules may be controlled or coordinated in their operation by an operating system (OS) or other form of organizational platform.

As shown in the figure, the example architecture 300 includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module. Such function, method, process, or operation may include those used to implement one or more aspects of the inventive system and methods, such as (where as noted, certain of the functions or operations may be executed by a data processing platform or interface located within a country or region in which data restrictions apply, and others of the functions or operations may be executed by a centralized data processing platform located outside of that country or region):
Identifying data or information that is subject to restrictions concerning its transfer and/or storage outside of a defined region or country;
Generating a token or other form of identifier and using that token or identifier as a replacement for the identified data or information in a request for information or the results of one or more data processing operations;
Locally storing the identified data or information in a data storage element within the defined region or country, with the stored data or information being retrievable based on the token or identifier;
Receiving and processing the request for information or the results of one or more data processing operations at a centralized data processing platform outside of the region or country in which the restrictions apply;
If applicable, determining that responding to such a request will require providing the identified data or information that is subject to restriction;
Generating the response, where if applicable, this includes inserting the token in the response to the request in place of the restricted data;
Receiving and processing the response within the region or country, including using the token to access the locally stored restricted data and inserting that data into the response;
Presenting the response, including the restricted data, to the requester;
Receiving a request for an application or service at a routing logic engine of a central data processing platform;
Processing the request to determine if responding or providing a requested service will involve using or accessing, or a user providing restricted data (which may involve determining a location of the requestor or recipient of the service or data); and
If processing the request will involve using or accessing, or a user providing restricted data, then implementing certain of the steps involved in responding to the request using a local data store instead of a central data store.
   As mentioned, certain of the above functions or operations may be performed by an application module or sub-module of the type illustrated in and described with reference to FIG. 2 or 3 (such as those involving the centralized data processing platform, for example, implementation of a ERP, CRM, or eCommerce function, or storage of a token representing restricted data and use of the token in responding to requests that would otherwise include the restricted data), while others of the above functions or operations may be performed by an application module or sub-module installed on a data processing platform that is part of a computing device (e.g., a server) located in the region or country in which the data restrictions apply (such as those involving identifying restricted data, generating and inserting a token into a request, storing the restricted data locally, etc.).

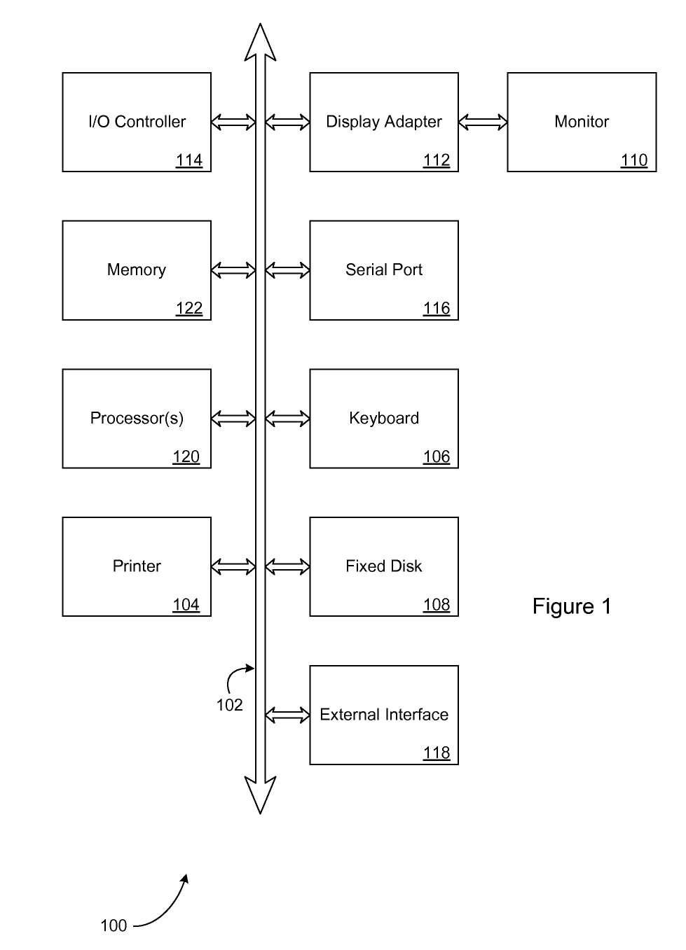

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 1) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

FIG. 3(b) is a block diagram illustrating a system architecture 350 in which one or more regional data centers is used in conjunction with a central data center 360 and multi-tenant business data processing platform 358 to restrict the transfer or storage of restricted data outside of the appropriate region or country, and that may be used when implementing an embodiment of the invention. FIG. 3(c) is a block diagram illustrating certain of the components or elements of a regional data center and associated elements, as shown in FIG. 3(b). In some embodiments of the invention the architecture and components of FIGS. 3(b) and 3(c) may be used to process restricted user information/data so that services and applications resident on a central data processing platform may be accessed by remote users without the restricted data being transferred or stored outside of a specific region or country.

As shown in the figures, each country or region in which data restrictions apply may include one or more local data processing platforms (e.g., 352, 354), with each such platform including a regional/local data center (numbered 1 . . . N, in the figure) and a platform interface. The platform interface operates to receive and process requests from users and where relevant, implement a data tokenizer process/component. The data tokenizer process/component operates to “tokenize” restricted or otherwise controlled data, such as personal data, medical data, confidential data, etc. The platform interface operates with the regional data center and data tokenizer to replace restricted data with a generated token and to store the restricted data locally in the regional data store. The local data processing platform(s) interconnect with one or more communications networks (356), which in turn interconnect with a centralized multi-tenant business data processing platform (358, such as element 208 of FIG. 1). The centralized multi-tenant business data processing platform interconnects with a central data center 360, which may include a data storage element for the data tokens.

Note that the example computing environments depicted in FIGS. 2 and 3(a) are not intended to be limiting examples. Alternatively, or in addition, computing environments in which an embodiment of the invention may be implemented include any suitable system or platform that permits users to access, process, and utilize data stored in a data storage element (e.g., a database) that can be accessed remotely over a network. Although further examples below may reference the example computing environment depicted in FIGS. 2 and 3(a), it will be apparent to one of skill in the art that the examples may be adapted for alternate computing devices, systems, and environments.

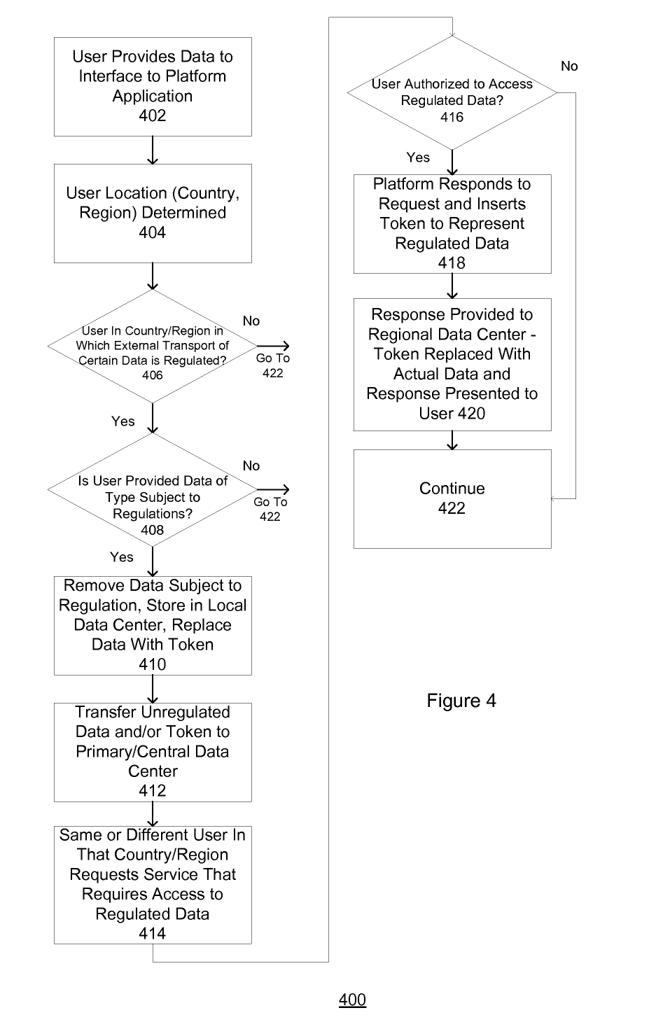

FIG. 4 is a flow chart or flow diagram illustrating a process, method, operation, or function 400 for protecting restricted user data from being stored or transferred outside of a specified region or country, and that may be used in implementing an embodiment of the invention. As shown in the figure, in one embodiment, a user provides data to an interface to a platform application (step or stage 402). Next, the invention determines the user location (e.g., the user's country or region) (step 404), based on one or more of an IP address, a user provided response, accessing previously stored user demographic data, etc. If the user is located in a country or region in which external transport of certain data is regulated, then the process continues to step 408. If the user is not located in such a country, then control passes to step 422.

Next, the invention determines if the user provided data is of the type subject to such regulations or restrictions (step 408). This may involve determining the type of user data (personal, demographic, confidential, etc.) and whether such a type of data is the subject of local regulations (by accessing a lookup table, an index of applicable regulations, etc.). If the user provided data is of the type subject to such regulations or restrictions, then control passes to step 410. If the user provided data is not of the type subject to such regulations or restrictions, then control passes to step 422. In step 410, the restricted or regulated data is replaced with a suitable token. The data is stored in a local data center and the token is associated with the data (via an index, lookup table or other suitable reference) and used to replace the data where applicable.

The token along with unregulated or unrestricted data may then be transferred to a primary or centralized data center that is typically an element of a centralized business data processing platform (step 412). The token(s) are stored in the centralized data center and associated with the data from which the token was generated (via communication of the association from the local or regional platform or data center, or another suitable source).

At a later time, the same or a different user in the country or region subject to the data regulations or restrictions requests a service from the centralized platform that requires access to the regulated data (step 414) (e.g., the service request might involve the processing of certain data, the use of certain data to represent information, etc.). The invention or a related system may then determine if the requesting user is authorized to access the regulated data (step 416). If the requesting user is authorized to access the regulated data, then control passes to step 418. If the requesting user is not authorized to access the regulated data, then control passes to step 422.

At step 418, the centralized data processing platform responds to the user's request by generating a response, where that response includes inserting the appropriate token (which may have been stored in the centralized data center) into the response in place of the restricted or regulated data. The response is then provided to the requesting user via the regional data processing platform. The regional data processing platform accesses the actual data corresponding to the token from the regional data center and replaces the token with the actual data in the response. The response is then presented to the requesting user (step 420).

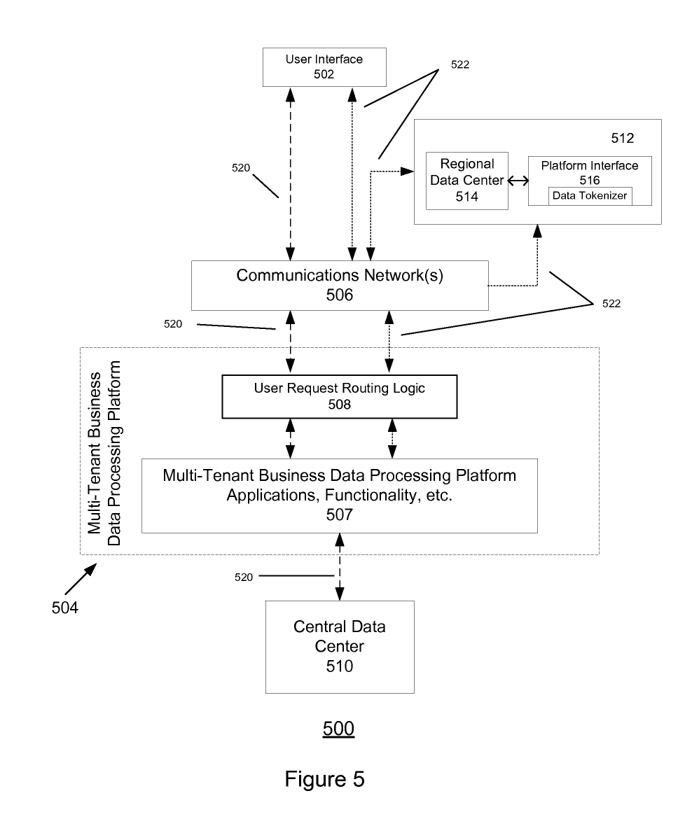

FIG. 5 is a block diagram illustrating components and the associated data flow of a system 500 that may be used to implement an embodiment of the invention. As shown in the figure, system 500 includes a user interface 502 by which a user (e.g., an employee or customer of a business) may interact with applications and data provided by a Multi-Tenant Business Data Processing Platform 504. The user may submit a request or attempt to access a service or application 507, which will typically be transported to the platform 504 by one or more suitable communications networks 506. Such networks 506 may include applicable wired and/or wireless networks and protocols (such as the Internet). The user request or accessing of the service or application 507 may be processed or interpreted by suitable routing logic 508. Routing logic 508 may in whole or in part determine whether the request or service/application access implicates protected or restricted data, such as by requesting access to that data or requiring a user to enter such data as part of completing a service request (such as a purchase using a credit card). The determination may be based in whole or in part on one or more of the following:
A determined or inferred location of the requestor/customer;
The service, application, or functionality being requested or accessed;
The type of data that is requested or may be needed to provide the requested service/data; or
A list or other data structure containing information about the types of data subject to protection or restriction in one or more regions, countries, or localities.

If the data being requested or the service/application being accessed is not one using or requiring input of protected or restricted data, then platform 504 may process and fulfill the request in a standard manner in which the Multi-Tenant Data Processing Platform Applications/Functionality 507 are implemented using data stored in a Central Data Center 510 (which may be integrated with platform 504 or implemented as one or more separate data stores), as suggested by the data flow corresponding to path 520. However, if the data being requested or the service/application being accessed is one using or requiring input of protected or restricted data, then platform 504 (e.g., routing logic 508 and/or Applications 507) may instead interact with local or regional platform infrastructure 512 to fulfill the user's request while protecting the restricted data, as suggested by one or more of the data flows corresponding to path(s) 522. This may be accomplished by use of a Regional/Local Data Center 514 and a Platform Interface/Data Tokenizer 516 (whose functions may be similar to those described with reference to FIGS. 3(b), 3(c), and 4).

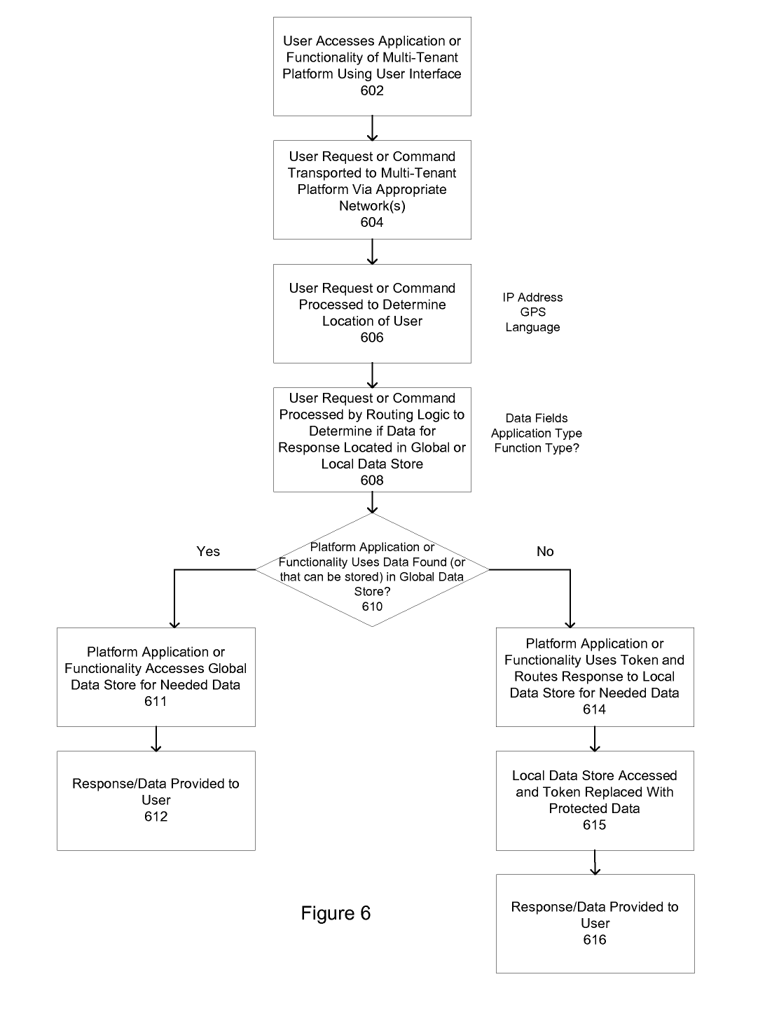

FIG. 6 is a flow chart or flow diagram illustrating a process, method, operation, or function for using routing logic to determine how to access an application or service resident on a central data processing platform, and that may be used in implementing an embodiment of the invention. As shown in the figure, a user (who may be a business employee or a customer of a business) may access an application or functionality of a multi-tenant platform using a suitable user interface (step or stage 602). The request or access attempt (such as a command or request) will typically be transported to the platform by one or more suitable communications networks (step or stage 604), such as a wired and/or wireless network. The user request or access attempt may be received by the platform and processed/interpreted to determine a location of the user (step or stage 606). This determination or inference of the location may be performed by a routing logic engine or other suitable processing element, and may be based on one or more of an IP address, GPS fix, the language of the request, a location associated with previous requests from that user, information about the user's location or role within a company, etc.

The routing logic engine or other suitable processing element may then determine if data that is needed to generate a response, provide access to the application/functionality, or that is expected to be provided by the user as part of using the application is (or should be) stored in a central data store or in a local/regional data store (step or stage 608). This may be determined, in whole or in part, by the application being accessed, the functions requested, etc. If the data is not protected or restricted to being maintained in a local/regional data store, then the platform application or functionality is used to access the data and generate a response or provide a service to the user (corresponding to the “Yes” branch of step or stage 610, and steps or stages 611 and 612).

However, if the data is protected or restricted to being maintained in a local/regional data store, then the platform application or functionality instead uses a “token” to represent the protected data and (by itself or using the routing logic engine, element 508 of FIG. 5) routes the response to the appropriate regional platform infrastructure (element 512 of FIG. 5) to fulfill the user's request while protecting the restricted data (corresponding to the “No” branch of step or stage 610 and step or stage 614). In response, the appropriate regional platform infrastructure may process the response so as to access a local/regional data store and replace one or more tokens with the appropriate data (step or stage 615), after which the response is provide to the user/requestor (step of stage 616), which may involve providing a service or access to a function to the customer.

In accordance with one embodiment of the invention, the system, apparatus, methods, processes, functions, and/or operations for controlling the access to and transfer of regulated or restricted data may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 1 is a diagram illustrating elements or components that may be present in a computer device or system 100 configured to implement a method, process, function, or operation in accordance with an embodiment of the invention. The subsystems shown in FIG. 1 are interconnected via a system bus 102. Additional subsystems include a printer 104, a keyboard 106, a fixed disk 108, and a monitor 110, which is coupled to a display adapter 112. Peripherals and input/output (I/O) devices, which couple to an I/O controller 114, can be connected to the computer system by any number of means known in the art, such as a serial port 116. For example, the serial port 116 or an external interface 118 can be utilized to connect the computer device 100 to further devices and/or systems not shown in FIG. 1 including a wide area network such as the Internet, a mouse input device, and/or a scanner. The interconnection via the system bus 102 allows one or more processors 120 to communicate with each subsystem and to control the execution of instructions that may be stored in a system memory 122 and/or the fixed disk 108, as well as the exchange of information between subsystems. The system memory 122 and/or the fixed disk 108 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method of operating a centralized data processing platform, comprising:
receiving a request for data or a service from a user at the centralized data processing platform;
processing the request to generate a response to the request, wherein the response includes one or more tokens representing data that is restricted to a specific country or region;
providing the response to an interface located within the specific country or region;
processing the response within the specific country or region to identify the one or more tokens;
using the one or more tokens to access the restricted data from a local data store located within the specific country or region;
replacing the one or more tokens with the restricted data; and
presenting the response to the user.

2. The method of claim 1, wherein the restricted data is one or more of personal data, identification data, or payment account data.

3. The method of claim 1, wherein the centralized data processing platform is a multi-tenant platform.

4. The method of claim 3, wherein the multi-tenant platform includes one or more of enterprise resource planning, customer relationship management, or eCommerce functionality.

5. The method of claim 1, wherein prior to receiving a request for data or a service from the user at the centralized data processing platform, the method further comprises:
receiving restricted data at the interface;
generating a token associated with the restricted data; and
storing the restricted data in the local data store.

6. A data processing system, comprising:
a regional or local data storage element;
a central data processing platform interface;
a data tokenizer;
a central data processing platform;
a central data storage element; and
an electronic data processor configured to execute a set of instructions, wherein when the instructions are executed, the central data processing platform is caused to implement a process to
receive a request for data or a service from a user at the centralized data processing platform;
process the request to generate a response to the request, wherein the response includes one or more tokens representing data that is restricted to a specific country or region;
provide the response to the central data processing platform interface located within the specific country or region;
process the response within the specific country or region to identify the one or more tokens;
use the one or more tokens to access the restricted data from the local data storage element located within the specific country or region;
replace the one or more tokens with the restricted data; and
present the response to the user.

7. The system of claim 6, wherein the restricted data is one or more of personal data, identification data, or payment account data.

8. The system of claim 6, wherein the central data processing platform is a multi-tenant platform.

9. The system of claim 8, wherein the multi-tenant platform includes one or more of enterprise resource planning, customer relationship management, or eCommerce functionality.

10. The system of claim 6, wherein prior to receiving a request for data or a service from the user at the central data processing platform, the process further comprises:
receiving restricted data at the central data processing platform interface;
operating the data tokenizer to generate a token associated with the restricted data; and
storing the restricted data in the local data storage element.

11. The system of claim 6, further comprising at least one regional or local data storage element, central data processing platform interface, and data tokenizer located in a plurality of regions or countries.

12. An apparatus for use in operating a central data processing platform, comprising:
an electronic data processor configured to execute a set of instructions, wherein when the instructions are executed, the central data processing platform is caused to implement a process to
receive a request for data or a service from a user at the centralized data processing platform;
process the request to generate a response to the request, wherein the response includes one or more tokens representing data that is restricted to a specific country or region;
provide the response to a central data processing platform interface located within the specific country or region;
process the response within the specific country or region to identify the one or more tokens;
use the one or more tokens to access the restricted data from the local data storage element located within the specific country or region;
replace the one or more tokens with the restricted data; and
present the response to the user.

13. The apparatus of claim 12, wherein the restricted data is one or more of personal data, identification data, or payment account data.

14. The apparatus of claim 12, wherein the central data processing platform is a multi-tenant platform.

15. The apparatus of claim 12, wherein the multi-tenant platform includes one or more of enterprise resource planning, customer relationship management, or eCommerce functionality.

16. The apparatus of claim 12, wherein prior to receiving a request for data or a service from the user at the central data processing platform, the process further comprises:
receiving restricted data at the central data processing platform interface;
operating the data tokenizer to generate a token associated with the restricted data; and
storing the restricted data in the local data storage element.
